(19) United States
(12) Patent Application Publication
(10) Pub. No.: US 2001/0012322 A1
(43) Pub. Date: Aug. 9, 2001

(54) Signal encoding transmission apparatus, signal decoding receiving apparatus, and program recording medium

(76) Inventors: Yoshitomi Nagaoka, Osaka (JP); Masaaki Kobayashi, Kawanishi-shi (JP); Masakazu Nishino, Osaka (JP); Seiichi Takeuchi, Osaka (JP)

Correspondence Address: Beveridge, DeGrandi, Weilacher & Young, L.L.P., Suite 800, 1850 M Street, N.W., Washington, DC, 20036, US

(21) Appl. No.: 09/775,643

(22) Filed: Feb. 5, 2001

(30) Foreign Application Priority Data
Feb. 8, 2000 (JP) 2000-030,705

(51) Int. Cl. H04B 1/66

(52) U.S. Cl. 375/240

(57) ABSTRACT

A signal encoding transmission apparatus has

layered encoding means of structuring a transmission signal in a plurality of layers in a hierarchy, and of outputting a plurality of compressed bit streams generated by encoding the respective layered signals; and

modulating/transmitting means of (1) modulating each of the output compressed bit streams by a modulation method determined for each layer, and/or (2) transmitting the compressed bit streams by using carriers determined for each layer.

### BACKGROUND OF THE INVENTION

1. Field of the Invention

The present invention relates to a signal encoding transmission apparatus, a signal decoding receiving apparatus, and a program recording medium.

2. Related Art of the Invention

The configuration and operation of a prior art signal encoding transmission apparatus and a prior art signal decoding receiving apparatus will be described below with reference to FIGS. 7 and 8.

First, the configuration and operation of the prior art signal encoding transmission apparatus will be described below with reference to FIG. 7. In FIG. 7, reference numeral 1001 is a video signal encoder, and 1002 is a modulator/transmitter.

A video signal input into the video signal encoder 1001 is subjected to prescribed encoding (in this example, MPEG-2 compression encoding), to generate a compressed bit stream.

The compressed bit stream thus generated is divided in the modulator/transmitter 1002 into blocks of 64 bits, and digital modulation is applied to contiguous N blocks (N is an integer not smaller than 2) using one carrier for each block for multicarrier transmission.

Next, the configuration and operation of the prior art signal decoding receiving apparatus will be described below with reference to FIG. 8. In FIG. 8, reference numeral 1003 is a receiving demodulator, and 1004 is a video signal decoder.

The N modulated signals sent out by a multicarrier transmission method, as described above, and received by the receiving demodulator 1003 are demodulated in accordance with the digital modulation process performed in the signal encoding transmission apparatus. The N compressed bit streams obtained as the result of the demodulation are combined into one compressed bit stream for output.

The video signal decoder 1004 reconstructs the video signal by decoding the compressed bit stream output from the receiving demodulator 1003, an inverse operation of the MPEG-2 compression encoding applied in the prior art signal encoding transmission apparatus.

### SUMMARY OF THE INVENTION

In the transmission system comprising the prior art signal encoding transmission apparatus and signal decoding receiving apparatus, the video signal cannot be decoded unless all the carrier signals of the multicarrier transmission are received at the signal decoding receiving apparatus.

The prior art thus has had the problem that, under poor reception conditions (for example, in the case of mobile communications), since all the carrier signals cannot be received correctly, there frequently arises the situation where the video signal cannot be decoded, resulting in a total inability to reconstruct the video signal.

### SUMMARY OF THE INVENTION

In view of the above problem, it is an object of the present invention to provide a signal encoding transmission apparatus, a signal decoding receiving apparatus, and a program recording medium, wherein signal reconstruction can be accomplished even under poor reception conditions.

The 1^{st} invention of the present invention is a signal encoding transmission apparatus comprising:

layered encoding means of structuring a transmission signal in a plurality of layers in a hierarchy, and of outputting a plurality of compressed bit streams generated by encoding the respective layered signals; and

modulating/transmitting means of (1) modulating each of the output compressed bit streams by a modulation method determined for each layer, and/or (2) transmitting the compressed bit streams by using carriers determined for each layer.

The 2^{nd} invention of the present invention is a signal encoding transmission apparatus according to 1^{st} invention, wherein determining the modulation method means determining a digital modulation method on the basis of a correspondence between each layer and resistance to transmission noise.

The 3^{rd} invention of the present invention is a signal encoding transmission apparatus according to 1^{st} invention, wherein determining the carriers means determining carriers on the basis of a correspondence between each layer and the influence of transmission noise.

The 4^{th} invention of the present invention is a signal encoding transmission apparatus according to 2^{nd} invention, wherein the modulation scheme is determined so that at least the compressed bit stream of the lowest layer in the hierarchy has the highest resistance to transmission noise among all of the plurality of compressed bit streams.

The 5^{th} invention of the present invention is a signal encoding transmission apparatus according to 3^{rd} invention, wherein the carriers are determined so that at least the compressed bit stream of the lowest layer in the hierarchy is the least susceptible to transmission noise among all of the plurality of compressed bit streams.

The 6^{th} invention of the present invention is a signal decoding receiving apparatus comprising:

receiving means of receiving compressed bit streams generated by encoding a transmission signal into a plurality of layers in a hierarchy, and (1) modulated by a modulation method determined for each layer and/or (2) transmitted by using carriers determined for each layer, and of outputting the compressed bit streams corresponding to the respective layers on the basis of first prescribed criteria;

demodulating means of demodulating the compressed bit streams on the basis of second prescribed criteria; and

layered decoding means of reconstructing the transmission signal by decoding the respectively demodulated compressed bit streams.

The 7^{th} invention of the present invention is a signal decoding receiving apparatus according to 6^{th} invention, wherein the compressed bit streams to be received by the receiving means are transmitted using the carriers determined for the respective layers, and

the first prescribed criteria are the criteria based on the determination of the carriers.

The 8^{th} invention of the present invention is a signal decoding receiving apparatus according to 6^{th} invention, wherein the compressed bit streams to be received by the receiving means are modulated using the modulation methods determined for the respective layers, and

the second prescribed criteria are the criteria based on the determination of the modulation methods.

The 9^{th} invention of the present invention is a signal decoding receiving apparatus according to any one of 6^{th} to 8^{th} inventions, wherein the layered decoding means is able to reconstruct the transmission signal by using at least the compressed bit stream of the lowest layer in the hierarchy among the demodulated compressed bit streams.

The 10^{th} invention of the present invention is a signal encoding transmission apparatus comprising

modulating/transmitting means of (1) modulating a plurality of compressed bit streams by a modulation method determined based on predetermined criteria, and/or (2) transmitting the plurality of compressed bit streams by using carriers determined based on the predetermined criteria.

The 11^{th} invention of the present invention is a signal encoding transmission apparatus according to 10^{th} invention, wherein the plurality of compressed bit streams are given priorities in accordance with the predetermined criteria.

The plurality of compressed bit streams consist, for example, of a video stream and a voice stream, and the voice stream is given priority and carriers in the center portion less susceptible to noise are used for transmission of the voice. Alternatively, the plurality of compressed bit streams consist, for example, of a commercial video stream and other video streams, and the commercial video stream is given priority.

The 12^{th} invention of the present invention is a signal encoding transmission apparatus according to 10^{th} invention, further comprising encoding means of generating the plurality of compressed bit streams by encoding a plurality of transmission signals respectively.

The 13^{th} invention of the present invention is a signal encoding transmission apparatus according to 10^{th} invenion, further comprising encoding means of generating the plurality of compressed bit streams by encoding one or more transmission signals, and wherein

when the number of transmission signals is one, the encoding means generates the plurality of compressed bit streams by structuring the one transmission signal in a plurality of layers in a hierarchy and by encoding the respective layered signals, and

when the number of transmission signals is more than one, the encoding means generates the plurality of compressed bit streams by encoding the more than one transmission signal respectively.

The 14^{th} invention of the present invention is a signal decoding receiving apparatus comprising:

receiving means of receiving compressed bit streams generated by encoding a transmission signal, and (1) modulated by a modulation method determined based on predetermined criteria and/or (2) transmitted by using carriers determined based on predetermined criteria, and for outputting a plurality of compressed bit streams on the basis of first prescribed criteria;

demodulating means of demodulating the plurality of compressed bit streams on the basis of second prescribed criteria; and

decoding means of reconstructing the transmission signal by decoding the demodulated compressed bit streams.

The 15^{th} invention of the present invention is a signal decoding receiving apparatus according to 14^{th} invention, wherein the compressed bit streams to be received by the receiving means are transmitted using the carriers determined based on the predetermined criteria, and

the first prescribed criteria are the criteria based on the determination of the carriers.

The 16^{th} invention of the present invention is a signal decoding receiving apparatus according to 14^{th} invention, wherein the compressed bit streams to be received by the receiving means are modulated using the modulation methods determined based on the predetermined criteria, and

the second prescribed criteria are the criteria based on the determination of the modulation methods.

The 17^{th} invention of the present invention is a signal decoding receiving apparatus according to any one of 14^{th} to 16^{th} inventions, wherein the number of transmission signals is one or more than one, and

when the number of transmission signals is one, the one transmission signal is encoded into a plurality of layers in a hierarchy, while

when the number of transmission signals is more than one, the more than one transmission signal are encoded individually, and wherein

(1) when the number of transmission signals is one, the decoding means is able to reconstruct the transmission signal by using at least the compressed bit stream of the lowest layer in the hierarchy among the plurality of compressed bit streams, and

(2) when the number of transmission signals is more than one, the decoding means is able to reconstruct the transmission signals by using the compressed bit streams corresponding to the respective transmission signals among the plurality of compressed bit streams.

The 18^{th} invention of the present invention is a program recording medium having a program and/or data recorded thereon for enabling a computer to implement all or part of the functions of all or part of the means of the invention described in any one of 1^{st} to 17^{th} inventions, wherein the program recording medium is computer readable.

### BRIEF DESCRIPTION OF THE DRAWINGS

[FIG. 1]

FIG. 1 is a block diagram of a signal encoding transmission apparatus according to the present invention.

[FIG. 2]

FIG. 2 is a block diagram of a signal decoding receiving apparatus according to the present invention.

[FIG. 3]

FIG. 3(a) is a diagram for explaining the transmission of one bit stream in accordance with a multicarrier method, and

FIG. 3(b) is a second diagram for explaining the transmission of two bit streams in accordance with a multicarrier method.

[FIG. 4]

FIG. 4 is a block diagram of a signal encoding transmission apparatus according to the present invention.

[FIG. 5]

FIG. 5 is a block diagram of a signal decoding receiving apparatus according to the present invention.

[FIG. 6]

FIG. 6 is a diagram for explaining the transmission of bit streams in accordance with a multicarrier method.

[FIG. 7]

FIG. 7 is a block diagram of a signal encoding transmission apparatus according to the prior art.

[FIG. 8]

FIG. 8 is a block diagram of a signal decoding receiving apparatus according to the prior art.

### DESCRIPTION OF THE REFERENCE NUMERALS

101. VIDEO SIGNAL LAYERED ENCODER

102. DIGITAL MODULATOR

103. MULTICARRIER TRANSMITTER

201. MULTICARRIER RECEIVER

202. DIGITAL DEMODULATOR

203. VIDEO SIGNAL LAYERED DECODER

104, 1001. VIDEO SIGNAL ENCODER

1002. MODULATOR/TRANSMITTER

1003. RECEIVING DEMODULATOR

204, 1004. VIDEO SIGNAL DECODER

### PREFERRED EMBODIMENTS OF THE INVENTION

Embodiments according to the present invention will be described below with reference to drawings.

(Embodiment 1)

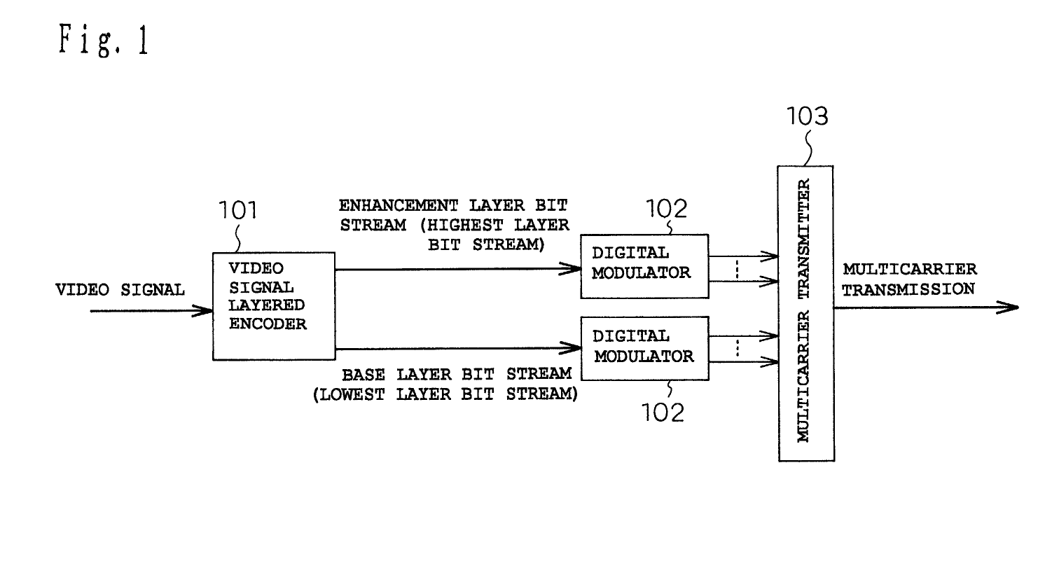

The configuration and operation of a signal encoding transmission apparatus and a signal decoding receiving apparatus according to a first embodiment will be described below by referring primarily to FIGS. 1 to 3.

First, the configuration and operation of the signal encoding transmission apparatus according to the first embodiment will be described by referring primarily to FIG. 1.

In FIG. 1, reference numeral 101 is a video signal layered encoder, 102 is a digital modulator, and 103 is a multicarrier transmitter.

The video signal layered encoder 101 in the first embodiment corresponds to the layered encoding means of the present invention. The digital modulator 102 and the multicarrier transmitter 103 in the first embodiment together constitute the modulating/transmitting means of the present invention.

The video signal layered encoder 101 generates two compressed bit streams by encoding the input video signal into two layers in accordance with the Spatial Scalable Profile defined in MPEG-2 (ISO/IEC 13812-2). In the following description, the compressed bit stream of the first layer will be referred to as the base layer bit stream (the lowest layer bit stream), and the compressed bit stream of the second layer as the enhancement layer bit stream (the highest layer bit stream).

The digital modulators 102 first divide the thus generated two compressed bit streams by a prescribed number of bits (64 bits in the first embodiment), and then modulate the respective divided signals into digital modulated signals by prescribed modulation methods, and the multicarrier transmitter 103 transmits out the digital modulated signals by a multicarrier method using 13 kinds of carriers. It will be appreciated here that the prescribed number of bits need not necessarily be limited to 64 bits.

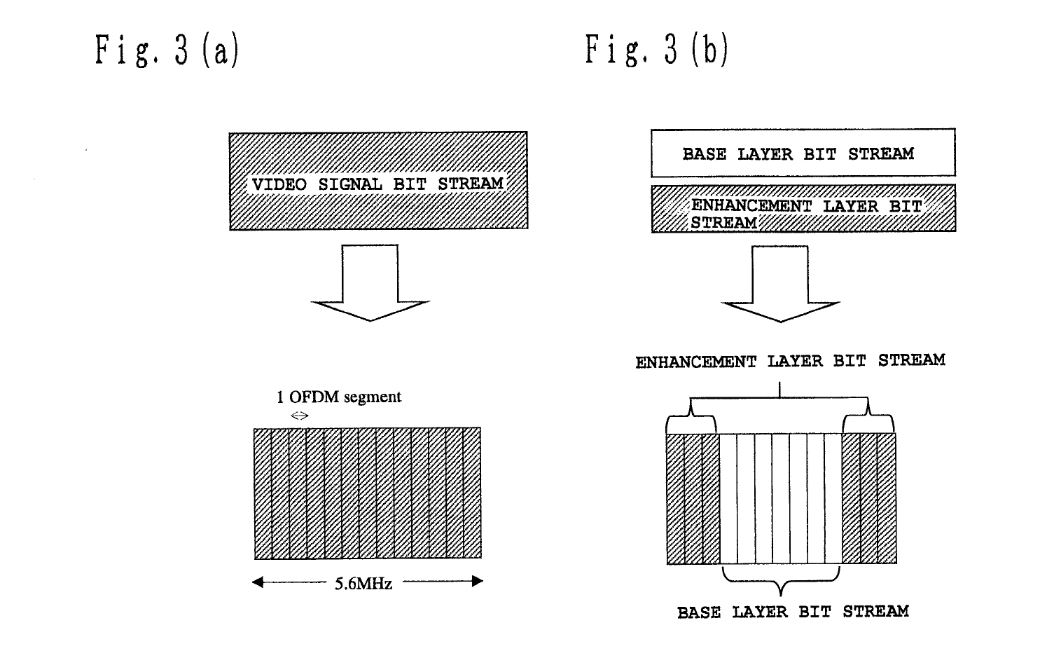

Referring now to FIG. 3, the modulation method and the transmission method using the multicarrier method (hereinafter sometimes called the multicarrier transmission method) according to the first embodiment will be described in further detail below.

The first embodiment assumes terrestrial digital broadcasting as an ideal mode of application and employs OFDM (Orthogonal Frequency Division Multiplex) as the multicarrier transmission method. In the terrestrial digital broadcasting currently being studied, the total bandwidth is 5.6 MHz, and 13 carriers called OFDM segments are transmitted by OFDM using the 5.6 MHz bandwidth.

If the number of video signal bit streams is one, as shown in FIG. 3(a), this one video signal bit stream is encoded, and then divided sequentially by 64 bits. Then these diveded signals are modulated by a digital modulation method such as DQPSK (Differential Quadrature Phase Shift Keying) QPSK (Quadrature Phase Shift Keying), 16 QAM (Quadrature Amplitude Modulation), or 64 QAM. Such modulated signals are then cyclically allocated to 13 kinds of carriers called as OFDM segments.

In the first embodiment, one video signal is structured into two layers, and the signals in the respective layers are encoded to generate two compressed bit streams, i.e., the base layer bit stream and the enhancement layer bit stream, as earlier described. Then, the base layer bit stream is divided by 64 bits, each of which is modulated into a digital modulated signal, and the modulated signals are allocated cyclically to central 7 kinds of carriers among the 13 kinds of carriers as shown in FIG. 3(b). And the enhancement layer bit stream is divided by 64 bits, each of which is modulated into a digital modulated signal, and the modulated signals are allocated cyclically to remaining 6 kinds of carriers at both sides among the 13 kinds of carriers as shown FIG. 3(b). These allocated signals are transmitted by the OFDM.

More specifically, the seven divided blocks of the base layer bit stream are each modulated by QPSK, a digital modulation method having high resistance to transmission noise, and the six divided blocks of the enhancement layer bit stream are each modulated by 16 QAM, a digital modulation method having high transmission efficiency. Since the carriers occupying the center portion of the frequency band can be transmitted with better conditions than the carriers occupying the side portions, the base layer bit stream is transmitted using the seven carriers occupying the center portion of the frequency band (see FIG. 3(b)) and the enhancement layer bit stream is transmitted using the six carriers occupying the side portions of the frequency band (see FIG. 3(b)). Another example of a digital modulation method having high transmission efficiency is 32 QAM.

Since the compressed bit stream having high importance, such as the base layer bit stream, is modulated by the digital modulator 102 using a digital modulation method having high resistance to transmission noise, and transmitted out by the multicarrier transmitter 103 using carriers having high transmission efficiency for multicarrier transmission, the signal encoding transmission apparatus of the first embodiment can transmit the bit stream without being substantially affected by noise or the like. Accordingly, at the signal decoding receiving apparatus, the video signal reconstructed by decoding the base layer bit stream can be obtained for reproduction even under noisy transmission conditions, as will be described later.

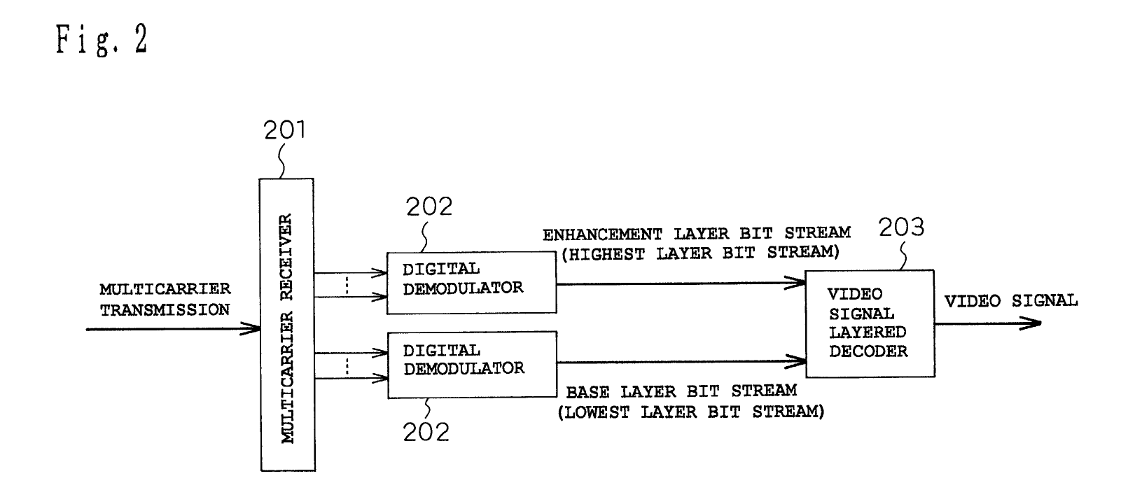

Next, the configuration and operation of the signal decoding receiving apparatus according to the first embodiment will be described by referring primarily to FIG. 2.

In FIG. 2, reference numeral 201 is a multicarrier receiver, 202 is a digital demodulator, and 203 is a video signal layered decoder.

The multicarrier receiver 201 in the first embodiment corresponds to the receiving means of the present invention. The digital demodulator 202 in the first embodiment corresponds to the demodulating means of the present invention. The video signal layered decoder 203 in the first embodiment corresponds to the layered decoding means of the present invention.

Of the multicarrier signals transmitted as earlier described, the multicarrier receiver 201 receives signals within the specified band and supplies the received signals to the digital demodulators 202.

More specifically, based on the fact the base layer bit stream is transmitted using the seven carriers occupying the center portion of the frequency band (see FIG. 3(b)), the multicarrier receiver 201 receives the modulated signals corresponding to the base layer bit stream and supplies them to the corresponding digital demodulator 202. Likewise, based on the fact that the enhancement layer bit stream is transmitted using the six carriers occupying the side portions of the frequency band (see FIG. 3(b)), the multicarrier receiver 201 receives the modulated signals corresponding to the enhancement layer bit stream and supplies them to the corresponding digital demodulator 202.

Each digital demodulator 202 demodulates the digital modulated signals of 64 bits each by reversing the modulation process performed in the digital modulator 102, and combines the demodulated signals into one compressed bit stream for output to the video signal layered decoder 203.

More specifically, based on the fact that the seven divided blocks of the base layer bit stream are digitally modulated by the QPSK digital modulation method, the digital demodulator 202 demodulates the seven modulated signals by reversing the QPSK modulation process, combines the seven demodulated signals into one bit stream, and supplies the thus reconstructed base layer bit stream to the video signal layered decoder 203. Likewise, based on the fact that the six divided blocks of the enhancement layer bit stream are digitally modulated by the 16 QAM digital modulation method, the digital demodulator 202 demodulates the six modulated signals by reversing the 16 QAM modulation process, combines the six demodulated signals into one bit stream, and supplies the thus reconstructed enhancement layer bit stream to the video signal layered decoder 203.

The video signal layered decoder 203 reconstructs the video signal by applying decoding, an inverse operation of the layered encoding, to the two compressed bit streams output from the digital demodulators 202.

More specifically, if the base layer bit stream alone is supplied from the digital demodulator 202, the video signal layered decoder 203 reconstructs the video signal by decoding this base layer bit stream. On the other hand, if both the base layer and enhancement layer bit streams are supplied from the respective digital demodulators 202, the video signal layered decoder 203 reconstructs the video signal by decoding the two compressed bit streams.

In the signal decoding receiving apparatus of the first embodiment, it is also possible to reconstruct the video by decoding only the base layer bit stream when both the base layer and enhancement layer bit streams are supplied from the respective digital demodulators 202. This serves to avoid a situation where an excessive load is applied to the signal decoding receiving apparatus.

There are, of course, cases where the quality of the video reconstructed by decoding only the base layer bit stream is lower than the quality of the video reconstructed by decoding both the base layer and enhancement layer bit streams, but since the base layer bit stream can be transmitted without being substantially affected by noise, as previously described, the signal decoding receiving apparatus of the first embodiment can reconstruct the video signal even under noisy transmission conditions.

For example, if the base layer bit stream is constructed to carry voice data, and if the signal encoding transmission apparatus and signal decoding receiving apparatus of the present invention are applied to the so-called video phone, since at least the voice data can be transmitted and received by decoding and reconstructing only the base layer bit stream even in areas where transmission/reception conditions are not good due to transmission noise, etc., the voice communication can be performed without being substantially affected by transmission noise, etc.

Consider, for example, the case where the video signal transmitted from the signal encoding transmitting apparatus of the present invention is received by a TV in a moving vehicle; in this case, even when the vehicle is moving in an area where the reception conditions are not good due to transmission noise, etc., the video signal can be reproduced by decoding only the base layer bit stream.

(Embodiment 2)

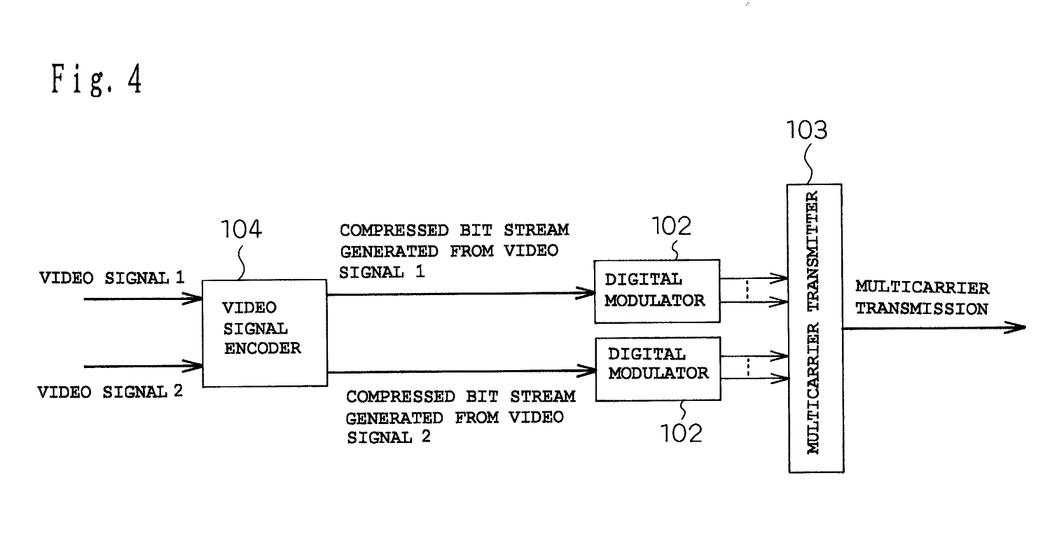

The configuration and operation of a signal encoding transmission apparatus and a signal decoding receiving apparatus according to a second embodiment will be described below by referring primarily to FIGS. 4 to 6.

First, the configuration and operation of the signal encoding transmission apparatus according to the second embodiment will be described by referring primarily to FIG. 4.

In FIG. 4, reference numeral 104 is a video signal encoder, 102 is a digital modulator, and 103 is a multicarrier transmitter.

The video signal encoder 104 is a means which, when only one transmission signal is input, is able to generate two compressed bit streams by structuring the one transmission signal into two layers and encoding the respective layered signals, and which, when there are two transmission signals, is able to generate two compressed bit streams by encoding the two transmission signals respectively. The layered encoding performed in the second embodiment is also based on the Spatial Scalable Profile defined in MPEG-2 (ISO/IEC 13818-2). The video signal encoder 104 in the second embodiment corresponds to the encoding means of the present invention.

When the number of transmission signals is one, the operation of the signal encoding transmission apparatus of the second embodiment is the same as that of the signal encoding transmission apparatus of the first embodiment; therefore, the following gives a detailed description for the case where the transmission signals consist of a low resolution video signal 1 and a low resolution video signal 2.

The video signal encoder 104 encodes the input video signal 1 and video signal 2, respectively, in accordance with the MPEG-2 described above, and outputs the respective compressed bit streams to the respective digital modulators 102.

The digital modulators 102 first divide the compressed bit streams respectively generated from the video signals 1 and 2 as described above by a prescribed number of bits (64 bits in the second embodiment), each of which is modulated into a digital modulated signal by prescribed modulation methods, and the multicarrier transmitter 103 transmits the digital modulated signals by a multicarrier method using 13 kinds of carriers.

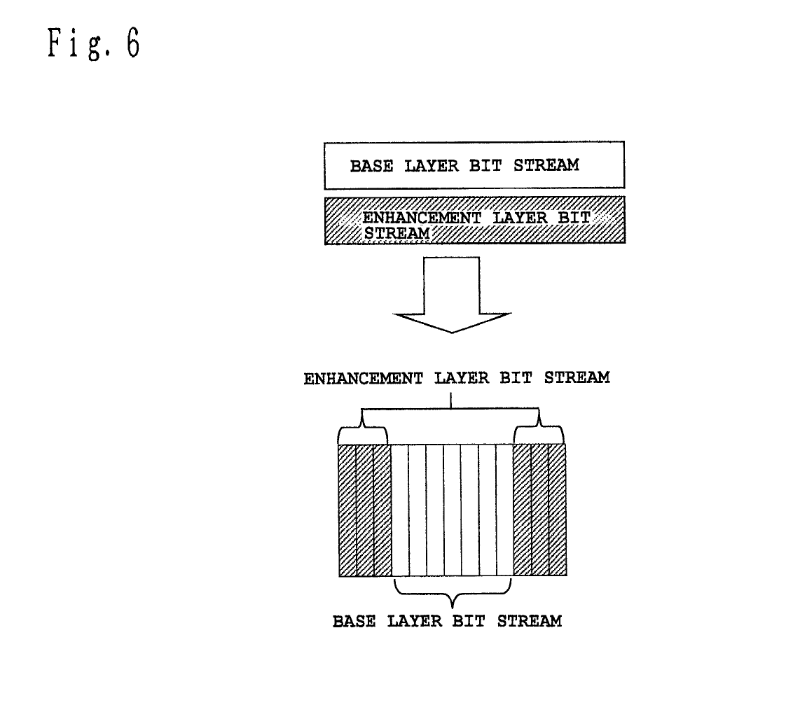

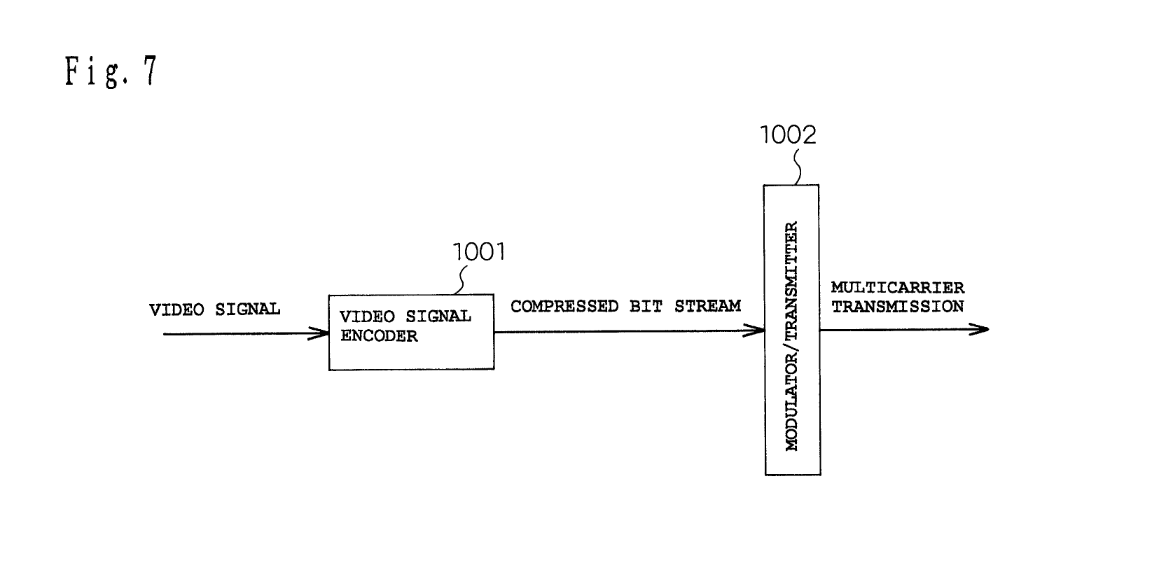

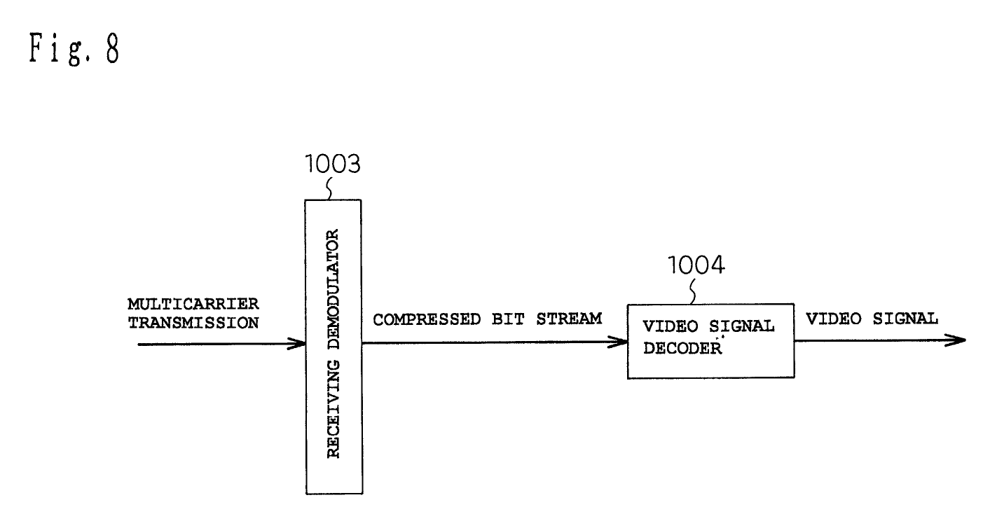

Referring now to FIG. 6, the modulation method and the multicarrier transmission method according to the second embodiment will be described in further detail below.

The second embodiment also assumes terrestrial digital broadcasting as an ideal mode of application and employs OFDM as the multicarrier transmission method. That is, the total bandwidth here is 5.6 MHz, and 13 carriers called OFDM segments are transmitted using the 5.6 MHz bandwidth.

In the second embodiment, two compressed bit streams are generated by encoding the video signals 1 and 2, respectively, as earlier described. Then, the compressed bit stream generated from the video signal 1 is divided into seven blocks, each of which is modulated into a digital modulated signal, while the compressed bit stream generated from the video signal 2 is divided into six blocks, each of which is modulated into a digital modulated signal, and the total of 13 modulated signals are each mapped as one carrier to one OFDM segment (see FIG. 6) for transmission by OFDM.

More specifically, the seven divided blocks of the compressed bit stream generated from the video signal 1 are each modulated by QPSK, and the six divided blocks of the compressed bit stream generated from the video signal 2 are each modulated by 16 QAM. Then, the compressed bit stream generated from the video signal 1 is transmitted using the seven carriers occupying the center portion of the frequency band (see FIG. 6), and the compressed bit stream generated from the video signal 2 is transmitted using the six carriers occupying the side portions of the frequency band (see FIG. 6).

By so doing, the compressed bit stream generated from the video signal 1 can be transmitted without being substantially affected by transmission noise. Accordingly, at the signal decoding receiving apparatus, the video signal 1 can be reconstructed by decoding the compressed bit stream generated from the video signal 1 even under noisy transmission conditions, as will be described later.

As earlier described, when only one transmission signal is input, the video signal encoder 104 is able to generate two compressed bit streams, the base layer bit stream and the enhancement layer bit stream, by structuring the one transmission signal into two layers and encoding the respective layered signals. With this arrangement, even when the transmission signal is a high resolution video signal, at least the base layer bit stream is transmitted without being substantially affected by noise. The operation that the signal encoding transmission apparatus of the second embodiment performs in this case is the same as operation of the signal encoding transmission apparatus of the first embodiment, and therefore, a detailed description will not be given here. It will, however, be noted that when only one low resolution video signal is input, the signal encoding transmission apparatus of the second embodiment does not perform the above-described layered encoding, but can generate one compressed bit stream by encoding the one low resolution video signal and 13 digital modulated signals at most (see FIG. 3(a)) for transmission by OFDM are generated.

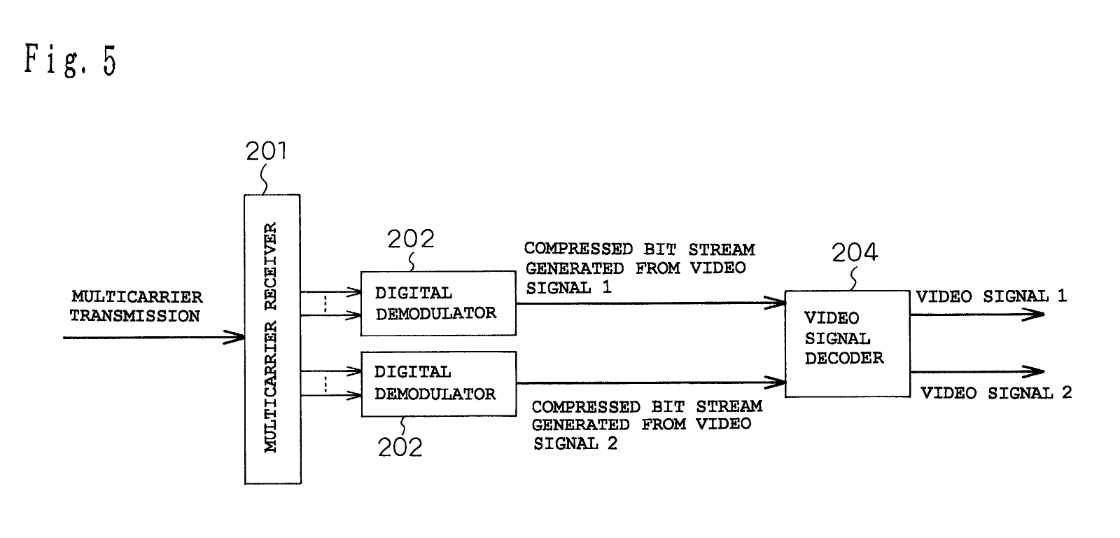

Next, the configuration and operation of the signal decoding receiving apparatus according to the second embodiment will be described by referring primarily to FIG. 5.

In FIG. 5, reference numeral 201 is a multicarrier receiver, 202 is a digital demodulator, and 204 is a video signal decoder.

The video signal decoder 204 is a means that is able to reconstruct all or part of the entire signal by using part of the compressed bit streams demodulated by the digital demodulators 202. More specifically, the video signal decoder 204 is a means that (1) when the compressed bit streams of two low resolution video signals are input, can decode the respective compressed bit streams and output the two low resolution video signals, the video signal 1 and the video signal 2, that (2-1) when two layered compressed bit streams are input, can decode them and output one high resolution video signal by performing an inverse operation of the layered encoding, and that (2-2) when the compressed bit stream of one low resolution video signal is input, can decode it and output the one low resolution video signal. The video signal decoder 204 of the second embodiment corresponds to the layered decoding means of the present invention.

When the number of video signals to be reconstructed is one (the cases (2-1) and (2-2) above), the operation of the signal decoding receiving apparatus of the second embodiment is the same as that of the signal decoding receiving apparatus of the first embodiment. In the following, a description will be given dealing with the case where the video signals to be reconstructed are the low resolution video signal 1 and low resolution video signal 2 (the case (1) above).

Of the multicarrier signals transmitted as earlier described, the multicarrier receiver 201 receives signals within the specified band and supplies the received signals to the digital demodulators 202.

More specifically, based on the fact that the seven divided blocks of the compressed bit stream generated from the video signal 1 are transmitted using the seven carriers occupying the center portion of the frequency band (see FIG. 6), the multicarrier receiver 201 receives the seven modulated signals corresponding to the compressed bit stream generated from the video signal 1 and supplies them to the corresponding digital demodulator 202. Likewise, based on the fact that the six divided blocks of the compressed bit stream generated from the video signal 2 are transmitted using the six carriers occupying the side portions of the frequency band (see FIG. 6), the multicarrier receiver 201 receives the six modulated signals corresponding to the compressed bit stream generated from the video signal 2 and supplies them to the corresponding digital demodulator 202.

Each digital demodulator 202 demodulates the digital modulated signals by reversing the modulation process performed in the digital modulator 102, and combines the demodulated signals into one compressed bit stream for output to the video signal decoder 204.

More specifically, based on the fact that the seven divided blocks of the compressed bit stream generated from the video signal 1 are modulated by the QPSK digital modulation method, the digital demodulator 202 demodulates the seven modulated signals by reversing the QPSK modulation process, combines the seven demodulated signals into one bit stream to reconstruct the compressed bit stream generated from the video signal 1, and supplies the thus reconstructed compressed bit stream to the video signal decoder 204. Likewise, based on the fact that the six divided blocks of the compressed bit stream generated from the video signal 2 are modulated by the 16 QAM digital modulation method, the digital demodulator 202 demodulates the six modulated signals by reversing the 16 QAM modulation process, combines the six demodulated signals into one bit stream to reconstruct the compressed bit stream generated from the video signal 2, and supplies the thus reconstructed compressed bit stream to the video signal decoder 204.

The video signal decoder 204 reconstructs the video signal by applying decoding, an inverse operation of the MPEG-2 compression encoding, to the two compressed bit streams output from the digital demodulators 202.

More specifically, when the compressed bit stream generated from the video signal 1 is input, the video signal decoder 204 reconstructs the video signal 1 by decoding the compressed bit stream generated from the video signal 1. Likewise, when the compressed bit stream generated from the video signal 2 is input, the video signal decoder 204 reconstructs the video signal 2 by decoding the compressed bit stream generated from the video signal 2. Here, the signal to be actually reconstructed is selected by the user. Since the compressed bit stream generated from the video signal 1 can be transmitted without being substantially affected by noise, as previously described, the signal decoding receiving apparatus of the second embodiment can reconstruct the video signal 1 even under noisy transmission conditions.

The signal encoding transmission apparatus and the signal decoding receiving apparatus of the present invention can be applied to so-called satellite broadcasting; in this case, if the video signal 1 is used for delivery of first satellite broadcasting and the video signal 2 for delivery of second satellite broadcasting, the first satellite broadcasting can be received even in areas where reception conditions are poor due to transmission noise, etc.

In the above embodiments, the signal layering and encoding according to the present invention has been performed in accordance with the Spatial Scalable Profile defined in MPEG-2 (ISO/IEC 13812-2), but instead, this maybe achieved using other means such as the Temporal Scalable Profile defined in MPEG-2 (ISO/IEC 13812-2). Furthermore, spatial or temporal layered coding schemes other than those defined in MPEG-2 maybe employed.

In the above embodiments, the signal layering according to the present invention has been performed by structuring the signal in two layers, but instead, the signal may be structured in two or more layers.

Further, in the above embodiments, modulating the compressed bit stream of each layer by a modulation method determined for each layer according to the present invention has meant modulating the base layer bit stream by QPSK, a digital modulation method having high resistance to transmission noise, and modulating the enhancement layer bit stream by 16 QAM, a digital modulation method having high transmission efficiency, but the invention is not limited to this particular example; the only requirement is that the compressed bit stream of each layer be modulated by a modulation method that matches the purpose of each layer.

In the above embodiments, the digital modulation having high resistance to transmission noise according to the present invention has meant QPSK, but instead, other modulation methods such as DQPSK may be used.

Further, in the above embodiments, transmitting the compressed bit stream of each layer by carriers determined for each layer according to the present invention has meant transmitting the base layer bit stream by using the carriers occupying the center portion of the frequency band and transmitting the enhancement layer bit stream by using the carriers occupying the side portions of the frequency band, but the invention is not limited to this particular example; the only requirement is that the compressed bit stream in the layer considered to have higher importance be transmitted using carriers so determined as to achieve more reliable transmission.

As for the carriers according to the present invention, the above embodiments have used 13 carriers called OFDM segments provided by a multicarrier method OFDM, but the invention is not limited to this particular example; other schemes than OFDM may be used for the multicarrier method, and the number of carriers may be determined arbitrarily.

Further, in the above embodiments, modulating the plurality of compressed bit streams by modulation methods determined based on predetermined criteria according to the present invention has meant modulating the compressed bit stream generated from the video signal 1 by QPSK and modulating the compressed bit stream generated from the video signal 2 by 16 QAM, but the invention is not limited to this particular example; the only requirement is that the plurality of compressed bit streams be modulated by modulation methods that match the respective purposes.

Further, in the above embodiments, transmitting the plurality of compressed bit streams by carriers determined based on predetermined criteria according to the present invention has meant transmitting the compressed bit stream generated from the video signal 1 by using the carriers occupying the center portion of the frequency band and transmitting the compressed bit stream generated from the video signal 2 by using the carriers occupying the side portions of the frequency band, but the invention is not limited to this particular example; the only requirement is that the compressed bit stream considered to have higher importance be transmitted using carriers so determined as to achieve more reliable transmission.

In the above embodiments, the number of compressed bit streams according to the present invention has been described as being one or two, but the invention is not limited to these particular numbers but two or more compressed bit streams may be used.

Further, in the above embodiments, the number of transmission signals according to the present invention has been described as being one or two, but the invention is not limited to these particular numbers but two or more transmission signals may be used.

In the first embodiment, outputting the compressed bit streams corresponding to the respective layers on the basis of the first prescribed criteria according to the present invention has meant outputting the base layer bit stream, based on the fact that the base layer bit stream is transmitted using the carriers occupying the center portion of the frequency band, and outputting the enhancement layer bit stream, based on the fact that the enhancement layer bit stream is transmitted using the carriers occupying the side portions of the frequency band, but the invention is not limited to this particular example; the only requirement is that the compressed bit streams corresponding to the respective layers be output based on the carriers corresponding to the respective layers.

In the first embodiment, demodulating the compressed bit streams on the basis of the second prescribed criteria according to the present invention has meant demodulating the base layer bit stream by reversing the QPSK modulation process, based on the fact that the base layer bit stream is modulated by QPSK, and demodulating the enhancement layer bit stream by reversing the 16 QAM modulation process, based on the fact that the enhancement layer bit stream is modulated by 16 QAM, but the invention is not limited to this particular example; the only requirement is that the respective compressed bit streams be demodulated using demodulation methods corresponding to the modulation methods employed for the respective compressed bit streams.

In the second embodiment, outputting the plurality of compressed bit streams on the basis of the first prescribed criteria according to the present invention has meant outputting the compressed bit stream generated from the video signal 1, based on the fact that the compressed bit stream generated from the video signal 1 is transmitted using the carriers occupying the center portion of the frequency band, and outputting the compressed bit stream generated from the video signal 2, based on the fact that the compressed bit stream generated from the video signal 2 is transmitted using the carriers occupying the side portions of the frequency band, but the invention is not limited to this particular example; the only requirement is that the respective compressed bit streams be output based on the carriers corresponding to the respective compressed bit streams.

In the second embodiment, demodulating the plurality of compressed bit streams on the basis of the second prescribed criteria according to the present invention has meant demodulating the compressed bit stream generated from the video signal 1 by reversing the QPSK modulation process, based on the fact that the compressed bit stream generated from the video signal 1 is modulated by QPSK, and demodulating the compressed bit stream generated from the video signal 2 by reversing the 16 QAM modulation process, based on the fact that the compressed bit stream generated from the video signal 2 is modulated by 16 QAM, but the invention is not limited to this particular example; the only requirement is that the respective compressed bit streams be demodulated using demodulation methods corresponding to the modulation methods employed for the respective compressed bit streams.

Further, a program recording medium, such as an optical disk or a magneto-optical disk, may be produced by recording thereon a program and/or data for enabling a computer to implement all or part of the functions of all or part of the means of the above-described embodiments, and the program and/or data read from the program recording medium may be used to carry out the above-described operations in collaboration with the computer.

As described above, the signal encoding transmission apparatus of the present invention is, for example, a signal encoding transmission apparatus that comprises: a video signal layered encoder for generating compressed bit streams by encoding a video signal into N layers (N is an integer not smaller than 2) at different spatial or temporal resolutions; a digital modulator for modulating the N compressed bit streams by dividing the compressed bit streams into a plurality of carriers; and a multicarrier transmitter for transmitting the compressed bit streams using the plurality of carriers in accordance with a prescribed multicarrier transmission method, and wherein: the lowest layer compressed bit stream output from the video signal layered encoder is modulated by the digital modulator using first digital modulation having high resistance to transmission noise, and is transmitted out by the multicarrier transmitter using carriers selected as being less susceptible to transmission noise from among the plurality of carriers, and any other layer compressed bit stream is modulated by the digital modulator using second digital modulation having less resistance to transmission noise than the first digital modulation, and is transmitted using carriers not used for the transmission of the lowest layer compressed bit stream.

The signal decoding receiving apparatus of the present invention is, for example, a signal decoding receiving apparatus that receives the compressed bit streams transmitted out by the above signal encoding transmission apparatus, and that comprises: a multicarrier receiver for receiving signals transmitted by the multicarrier method; a digital demodulator for digitally demodulating each carrier signal received by the multicarrier receiver by reversing the digital modulation performed in the signal encoding transmission apparatus; and a video signal layered decoder for reconstructing one video signal by decoding the N layer compressed bit streams output from the digital demodulator.

Further, the signal encoding transmission apparatus of the present invention is, for example, a signal encoding transmission apparatus that comprises: a video signal encoder for generating compressed bit streams by encoding a video signal; a digital modulator for digitally modulating the compressed bit streams by dividing them into a plurality of carriers; and a multicarrier transmitter for transmitting the compressed bit streams using the plurality of carriers in accordance with a prescribed multicarrier transmission method, wherein the input video signal to the video signal encoder consists of one high resolution video signal or at least one or more low resolution video signals, and wherein: when the input video signal consists of one high resolution video signal, the video signal encoder outputs compressed bit streams by encoding the input video signal into N layers (N is an integer not smaller than 2) at different spatial or temporal resolutions; when the input video signal consists of at least two or more low resolution video signals, the video signal encoder outputs compressed bit streams by applying prescribed encoding to the respective video signals; when the input video signal consists of one low resolution video signal, the video signal encoder outputs a compressed bit stream by applying prescribed encoding to the input video signal; when the input video signal consists of one high resolution video signal, the lowest layer compressed bit stream output from the video signal layered encoder is modulated by first digital modulation having high resistance to transmission noise, and is transmitted out by the multicarrier transmitter using carriers selected as being less susceptible to transmission noise from among the plurality of carriers, and any other layer compressed bit stream is modulated by second digital modulation having less resistance to transmission noise than the first digital modulation, and is transmitted out by the multicarrier transmitter using carriers not used for the transmission of the lowest layer compressed bit stream; and when the input video signal consists of at least one or more low resolution video signals, and when a critical low resolution video signal is defined, the compressed bit stream of the low resolution video signal defined as the critical low resolution video signal is modulated by the first digital modulation having high resistance to transmission noise, and is transmitted out by the multicarrier transmitter using carriers selected as being less susceptible to transmission noise from among the plurality of carriers, and any other compressed bit stream is modulated by the second digital modulation having less resistance to transmission noise than the first digital modulation, and is transmitted out by the multicarrier transmitter using carriers not used for the transmission of the critical low resolution video signal bit stream, while when the critical low resolution video signal is not defined, the compressed bit streams of all the low resolution video signals are digitally modulated by carrier basis and transmitted out by the multicarrier method.

Further, the signal decoding receiving apparatus of the present invention is, for example, a signal decoding receiving apparatus that receives the compressed bit streams transmitted out by the above signal encoding transmission apparatus, and that comprises: a multicarrier receiver for receiving signals transmitted by the multicarrier method; a demodulator for obtaining the compressed bit streams by digitally demodulating each carrier signal received by the multicarrier receiver by reversing the digital modulation performed in the signal encoding transmission apparatus; and a video signal layered decoder for reconstructing one high resolution video signal by decoding the N layer compressed bit streams when the input video signal to the signal encoding transmission apparatus consists of one high resolution video signal, and for reconstructing one low resolution video signal by decoding the compressed bit stream of the low resolution video signal specified by a user when the input video signal to the signal encoding transmission apparatus consists of at least one or more low resolution video signals.

Thus, according to the signal encoding transmission apparatus of the present invention, since the compressed bit stream having high importance, such as the base layer bit stream, is modulated by the digital modulator 102 using digital modulation having high resistance to transmission noise, and is transmitted out by the multicarrier transmitter 103 using carriers having high transmission efficiency for multicarrier transmission, the base layer bit stream can be transmitted reliably without being affected by noise.

On the other hand, according to the signal decoding receiving apparatus of the present invention, since the multicarrier receiver 201 receives the base layer bit stream transmitted out using carriers having high resistance to transmission noise during multicarrier transmission, the video signal decoded from the lowest layer compressed bit stream can be reliably reconstructed even under noisy transmission conditions.

Further, according to the signal encoding transmission apparatus of the present invention, when the input video signal is a high resolution video signal, the video signal layered encoder 104 performs layered encoding, and when the input video signal consists of a plurality of low resolution video signals, the encoder encodes each individual signal independently.

Since the base layer bit stream or the like having high importance is modulated by digital modulation having high resistance to transmission noise, and is transmitted out by the multicarrier transmitter 103 using carriers having high transmission efficiency for multicarrier transmission, at least the base layer bit stream or the like having high importance can be transmitted reliably without being affected by noise.

According to the signal decoding receiving apparatus of the present invention, since the multicarrier receiver 201 receives at least the highly important base layer bit stream or the like transmitted out using carriers having high resistance to transmission noise during multicarrier transmission, the video signal decoded from at least one compressed bit stream can be reliably reconstructed even under noisy transmission conditions.

In the first embodiment, the modulation method and the carriers according to the present invention have both been determined for each layer, but instead, only one or the other of these may be determined for each layer. For example, (1) when the determination of the modulation method is made for each layer, QPSK may be chosen as the modulation method for the base layer bit stream, with the six segments in the right-hand side of FIG. 3(b) chosen as its carriers, and 16 QAM may be chosen as the modulation method for the enhancement layer bit stream, with the seven segments in the left-hand side of FIG. 3(b) chosen as its carriers. On the other hand, (2) when the determination of the carriers is made for each layer, QPSK may be chosen as the modulation method for the base layer bit stream, with the six segments in the center portion of FIG. 3(b) chosen as its carriers, and QPSK may also be chosen as the modulation method for the enhancement layer bit stream, with the six segments in both end portions of FIG. 3(b) chosen as its carriers.

In the above case (1), by utilizing the fact that each compressed bit stream is modulated by a different modulation method, the signal decoding receiving apparatus can, after demultiplexing all carriers, recognize and output the compressed bit stream corresponding to each layer.

In the second embodiment, the modulation methods and carriers according to the present invention have both been determined based on predetermined criteria, but instead, only one or the other of these may be determined based on predetermined criteria. Further, when video signals 1 to 3 are input to the signal encoding transmission apparatus, for example, DQPSK may be chosen as the modulation method for the video signal 1 and QPSK for both the video signals 2 and 3.

The present invention can thus provide a signal encoding transmission apparatus, a signal decoding receiving apparatus, and a program recording medium, wherein signal reconstruction can be accomplished, for example, even under poor reception conditions.

What is claimed is:

1. A signal encoding transmission apparatus comprising:
layered encoding means of structuring a transmission signal in a plurality of layers in a hierarchy, and of outputting a plurality of compressed bit streams generated by encoding the respective layered signals; and
modulating/transmitting means of (1) modulating each of the output compressed bit streams by a modulation method determined for each layer, and/or (2) transmitting the compressed bit streams by using carriers determined for each layer.

2. A signal encoding transmission apparatus according to claim 1, wherein determining the modulation method means determining a digital modulation method on the basis of a correspondence between each layer and resistance to transmission noise.

3. A signal encoding transmission apparatus according to claim 1, wherein determining the carriers means determining carriers on the basis of a correspondence between each layer and the influence of transmission noise.

4. A signal encoding transmission apparatus according to claim 2, wherein the modulation scheme is determined so that at least the compressed bit stream of the lowest layer in the hierarchy has the highest resistance to transmission noise among all of the plurality of compressed bit streams.

5. A signal encoding transmission apparatus according to claim 3, wherein the carriers are determined so that at least the compressed bit stream of the lowest layer in the hierarchy is the least susceptible to transmission noise among all of the plurality of compressed bit streams.

6. A signal decoding receiving apparatus comprising:
receiving means of receiving compressed bit streams generated by encoding a transmission signal into a plurality of layers in a hierarchy, and (1) modulated by a modulation method determined for each layer and/or (2) transmitted by using carriers determined for each layer, and of outputting the compressed bit streams corresponding to the respective layers on the basis of first prescribed criteria;
demodulating means of demodulating the compressed bit streams on the basis of second prescribed criteria; and
layered decoding means of reconstructing the transmission signal by decoding the respectively demodulated compressed bit streams.

7. A signal decoding receiving apparatus according to claim 6, wherein the compressed bit streams to be received by the receiving means are transmitted using the carriers determined for the respective layers, and
the first prescribed criteria are the criteria based on the determination of the carriers.

8. A signal decoding receiving apparatus according to claim 6, wherein the compressed bit streams to be received by the receiving means are modulated using the modulation methods determined for the respective layers, and
the second prescribed criteria are the criteria based on the determination of the modulation methods.

9. A signal decoding receiving apparatus according to any one of claims 6 to 8, wherein the layered decoding means is able to reconstruct the transmission signal by using at least the compressed bit stream of the lowest layer in the hierarchy among the demodulated compressed bit streams.

10. A signal encoding transmission apparatus comprising modulating/transmitting means of (1) modulating a plurality of compressed bit streams by a modulation method determined based on predetermined criteria, and/or (2) transmitting the plurality of compressed bit streams by using carriers determined based on the predetermined criteria.

11. A signal encoding transmission apparatus according to claim 10, wherein the plurality of compressed bit streams are given priorities in accordance with the predetermined criteria.

12. A signal encoding transmission apparatus according to claim 10, further comprising encoding means of generating the plurality of compressed bit streams by encoding a plurality of transmission signals respectively.

13. A signal encoding transmission apparatus according to claim 10, further comprising encoding means of generating the plurality of compressed bit streams by encoding one or more transmission signals, and wherein
when the number of transmission signals is one, the encoding means generates the plurality of compressed bit streams by structuring the one transmission signal in a plurality of layers in a hierarchy and by encoding the respective layered signals, and
when the number of transmission signals is more than one, the encoding means generates the plurality of compressed bit streams by encoding the more than one transmission signal respectively.

14. A signal decoding receiving apparatus comprising:
receiving means of receiving compressed bit streams generated by encoding a transmission signal, and (1) modulated by a modulation method determined based on predetermined criteria and/or (2) transmitted by using carriers determined based on predetermined criteria, and for outputting a plurality of compressed bit streams on the basis of first prescribed criteria;
demodulating means of demodulating the plurality of compressed bit streams on the basis of second prescribed criteria; and
decoding means of reconstructing the transmission signal by decoding the demodulated compressed bit streams.

15. A signal decoding receiving apparatus according to claim 14, wherein the compressed bit streams to be received by the receiving means are transmitted using the carriers determined based on the predetermined criteria, and
the first prescribed criteria are the criteria based on the determination of the carriers.

16. A signal decoding receiving apparatus according to claim 14, wherein the compressed bit streams to be received by the receiving means are modulated using the modulation methods determined based on the predetermined criteria, and
the second prescribed criteria are the criteria based on the determination of the modulation methods.

17. A signal decoding receiving apparatus according to any one of claims 14 to 16, wherein the number of transmission signals is one or more than one, and
when the number of transmission signals is one, the one transmission signal is encoded into a plurality of layers in a hierarchy, while
when the number of transmission signals is more than one, the more than one transmission signal are encoded individually, and wherein
(1) when the number of transmission signals is one, the decoding means is able to reconstruct the transmission signal by using at least the compressed bit stream of the lowest layer in the hierarchy among the plurality of compressed bit streams, and
(2) when the number of transmission signals is more than one, the decoding means is able to reconstruct the transmission signals by using the compressed bit streams corresponding to the respective transmission signals among the plurality of compressed bit streams.

18. A program recording medium having a program and/or data recorded thereon for enabling a computer to implement all or part of the functions of all or part of the means of the invention described in any one of claims 1 to 17, wherein the program recording medium is computer readable.
